(19) United States
(12) Patent Application Publication
(10) Pub. No.: US 2023/0124869 A1
(43) Pub. Date: Apr. 20, 2023

(54) Apparatus for Housing Electric Fly Swatters

(71) Applicant: James Lee, Tustin, CA (US)

(72) Inventor: James Lee, Tustin, CA (US)

(21) Appl. No.: 17/501,619

(22) Filed: Oct. 14, 2021

(51) Int. Cl. A01M 3/02

(52) U.S. Cl. CPC A01M 3/025

(57) ABSTRACT

An electric fly swatter housing comprising a front plate, a back plate, and interior vertical bars sized to house a fly swatter head and to align the fly swatter head to avoid snag. The housing may include thin brushes along a housing mouth to brush away any bug residue on the fly swatter. The housing may include a removable chamber at the bottom of the housing to dispose of any bug residue.

### BACKGROUND OF THE INVENTION

The present invention relates to electric fly swatter storage apparatus.

An electric fly swatter is a handheld battery-powered device that is used to shock or kill bugs, namely flies or mosquitos, by means of electric current. Of all the various electric fly swatter designs, the most popular by far is the one that resembles a tennis racket.

Fly swatters, whether conventional or electrical, have become a staple of every home because dealing with flies or mosquitos or other insects, has become a way of life. Thus, fly swatters are very useful to eradicate these unwanted flies. However, the problem with both conventional and electrical models is that many users cannot locate the fly swatter when they need it because the fly swatters are placed in various locations around the home. Different people will use the fly swatter and leave it where they last used it. This creates frustration for the homeowner and a loss of opportunity to kill the flies.

Another common problem with fly swatters is that flies or other insects get stuck in the web of the fly swatter. If the flies are not disposed of immediately, the user may forget to remove any remnant of the dead flies, or if the user does not see fly remnants hanging on the fly swatter, it may be transferred to areas where people can digest the fly remnants. It is not uncommon for users to leave the fly swatter on dining room tables or in areas where children can touch or suck on the used fly swatter.

Another common problem is that the electric fly swatter can accidentally discharge if left unattended causing harm to young children.

A solution is needed for problems mentioned above.

### BRIEF SUMMARY OF THE INVENTION

The present invention addresses the above and other needs by providing a secure housing for tennis racket like electric fly swatters. The fly swatter includes a head electrically connected to batteries to stun or kill flies. The housing includes a front plate and a back plate which are securely attached creating a mouth at the top of the housing sized to receive the fly swatter head. The front plate and back plate include vertical bars residing inside the housing that are sized so that the fly swatter head does not snag when inserting into or removing from the housing. The housing preferably includes wall mounting features.

In accordance with one aspect of the invention, there is provided a fly swatter housing sized to fit the fly swatter head and having a mouth to slide the fly swatter head into the housing. The interior of the housing includes vertical bars to prevent snagging of the fly swatter head while inserting or removing from the housing. The fully assembled fly swatter housing provides a secure place to store away the fly swatter and it protects children from shocks from accidental discharge of the electric fly swatter.

In accordance with still another aspect of the invention, there is provided a fly swatter housing having brushes on opposite sides of the housing mouth to sweep away any fly residue left on the fly swatter head.

In accordance with yet another aspect of the invention, there is provided a fly swatter housing having a disposal mechanism to dispose of any dirt or residue deposited at the bottom of the housing by the fly swatter.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is an elevational view of the electric fly swatter housing according to the present invention;

FIG. 2 is an elevational view of a front plate of the electric fly swatter housing;

FIG. 3 is an elevational view of the back plate of the electric fly swatter housing;

FIG. 4 is an exploded view of the electric fly swatter housing;

FIG. 5 is a front orthogonal view of the electric fly swatter housing showing cross-sectional line 6-6;

FIG. 6 is a cross-sectional view along line 6-6 of the electric fly swatter housing with an electric fly swatter flush with the side of the housing;

FIG. 7 is a second cross-sectional view along line 6-6 of the electric fly swatter housing;

FIG. 8 top orthogonal view of the electric fly swatter housing;

FIG. 9 is a front orthogonal view of the electric fly swatter housing with removable disposal member;

FIG. 10 is a front view of an electric fly swatter;

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

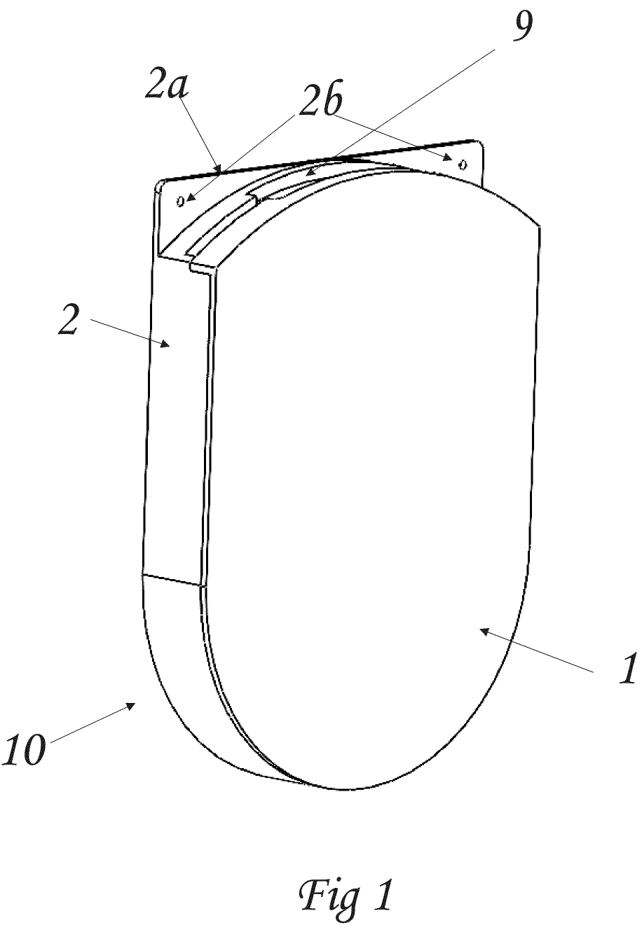

FIG. 1 is an elevational view of the fly swatter housing 10 showing a front plate 1 and a back plate 2. The front plate 1 has a curved top for aesthetics and to save on material cost. The back plate 2 having an extended flange 2a at the upper part of the back plate 2 and preferably includes wall mounting feature 2b.

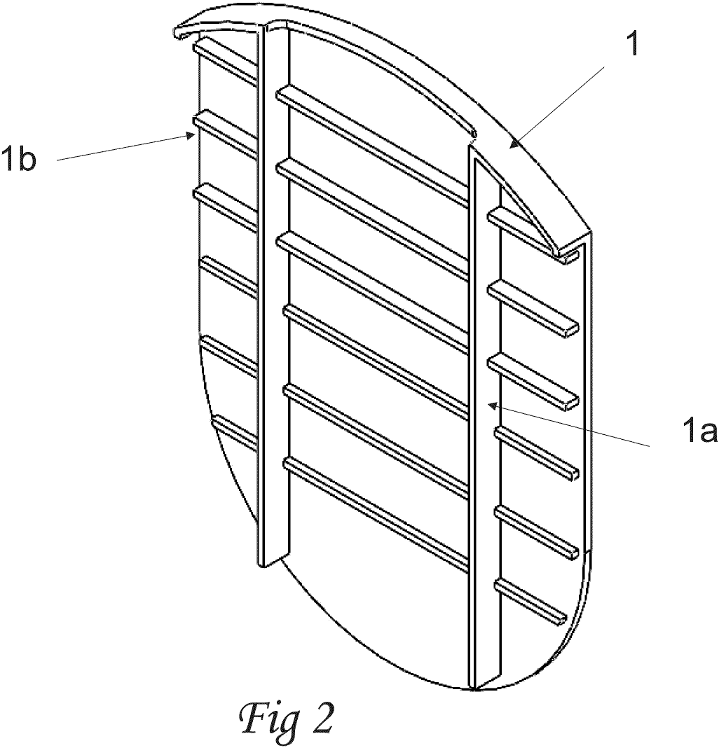

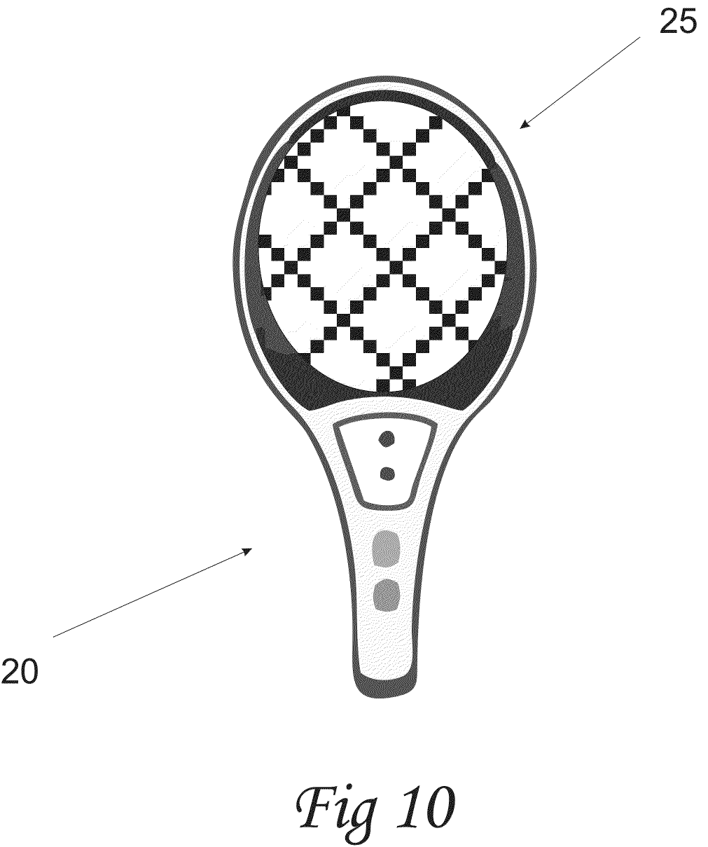

FIG. 2 is an elevational view of the front plate 1 showing vertical bars 1a and horizontal bars 1b. Horizontal bars 1b are for rigidity and strength and the vertical bars 1a are sized to align the fly swatter 20 (see FIG. 10) residing in the assembled housing 10.

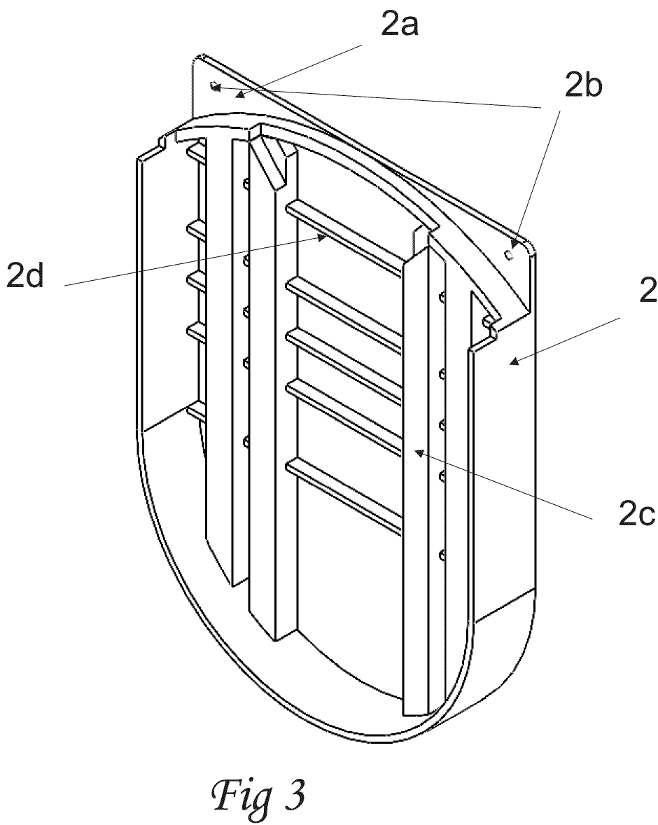

FIG. 3 is an elevational view of the back plate 2 showing the extended flange 2a with the mounting feature 2b on either end of the extended flange 2a, a vertical bar 2c, and horizontal bar 2d. The horizontal bar 2d for rigidity and strength and the vertical bar 2a are sized to align the fly swatter 20 residing in the assembled housing 10.

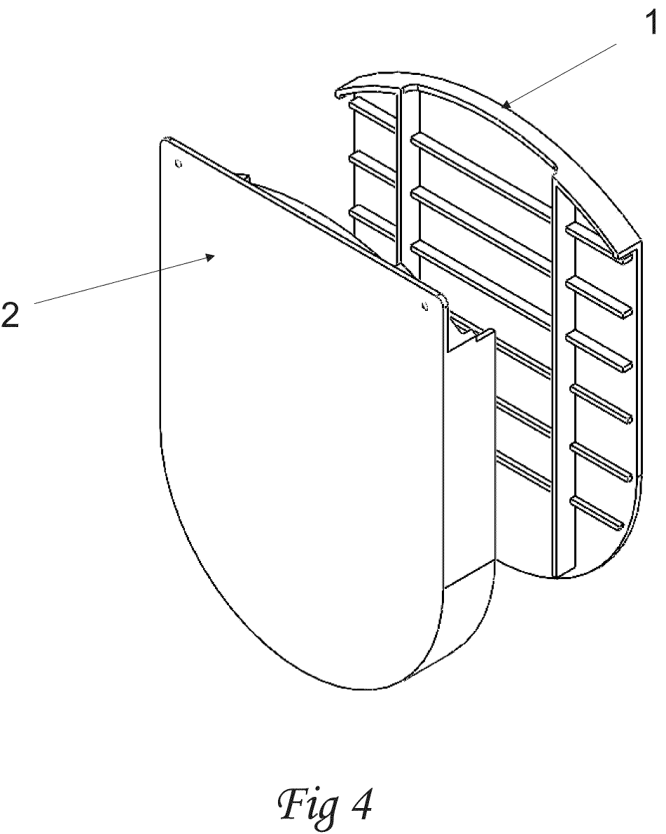

FIG. 4 is an exploded view of housing 10.

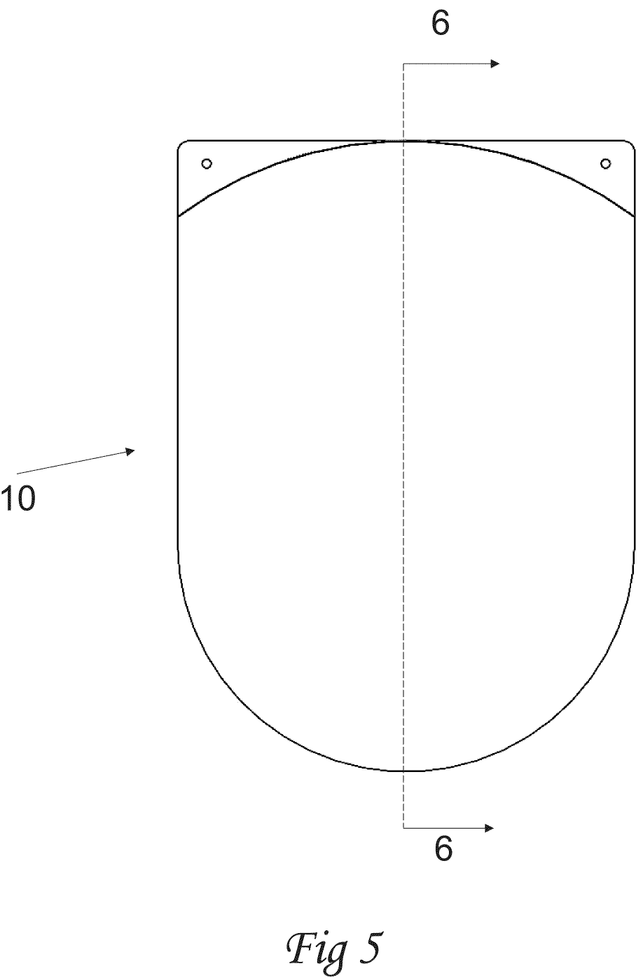

FIG. 5 is a front orthogonal view of the housing 10 reflecting a cross-sectional line 6-6.

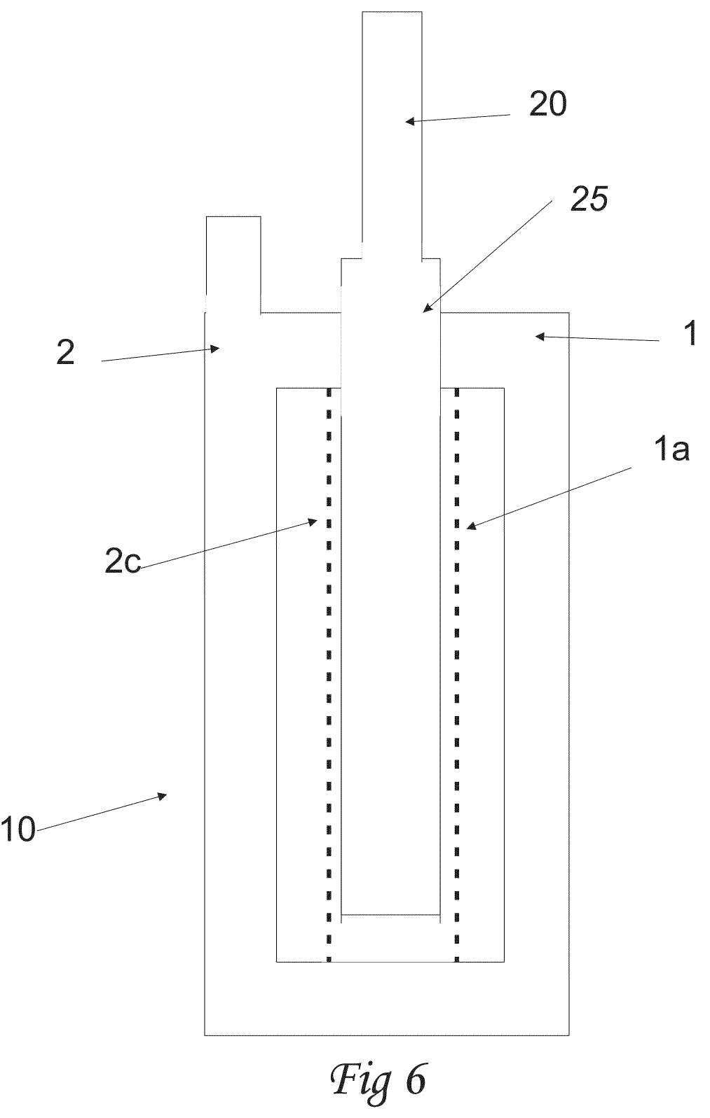

FIG. 6 is a cross-sectional view along line 6-6 of the FIG. 5 of the housing 10, showing the front plate vertical bar 1a, the back plate 2, the back plate vertical bar 2c, the fly swatter 20 and fly swatter head 25. FIG. 6 illustrates the fly swatter head 25 aligned by the vertical bars when the fly swatter 20 is residing in the housing 10.

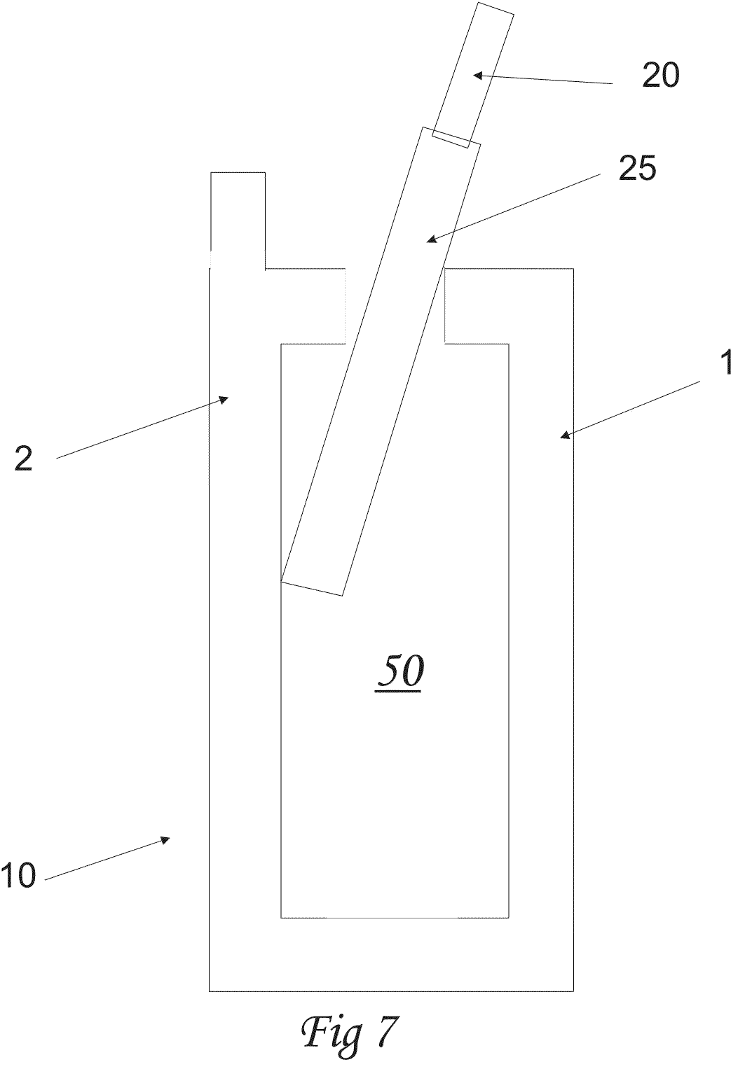

FIG. 7 is a cross-sectional view along line 6-6 of FIG. 5 of the housing 10 showing the front plate 1 without any vertical bars, the back plate 2 without any vertical bars, interior 50 and a fly swatter head 25. FIG. 7 illustrates the fly swatter head 25 being snagged at the opening of the housing 10 absent the vertical bars.

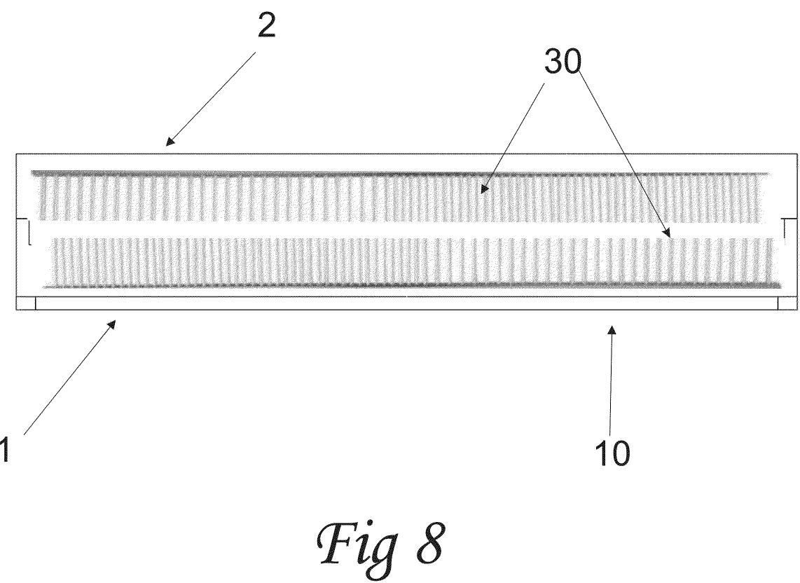

FIG. 8 is a top view of the housing 10, the front plate 1, the back plate 2, and brushes 30. The brushes 30 preferably reside on both sides of the mouth of the housing 10 to brush away any fly residue when a fly swatter head 25 is inserted into and out of the housing 10.

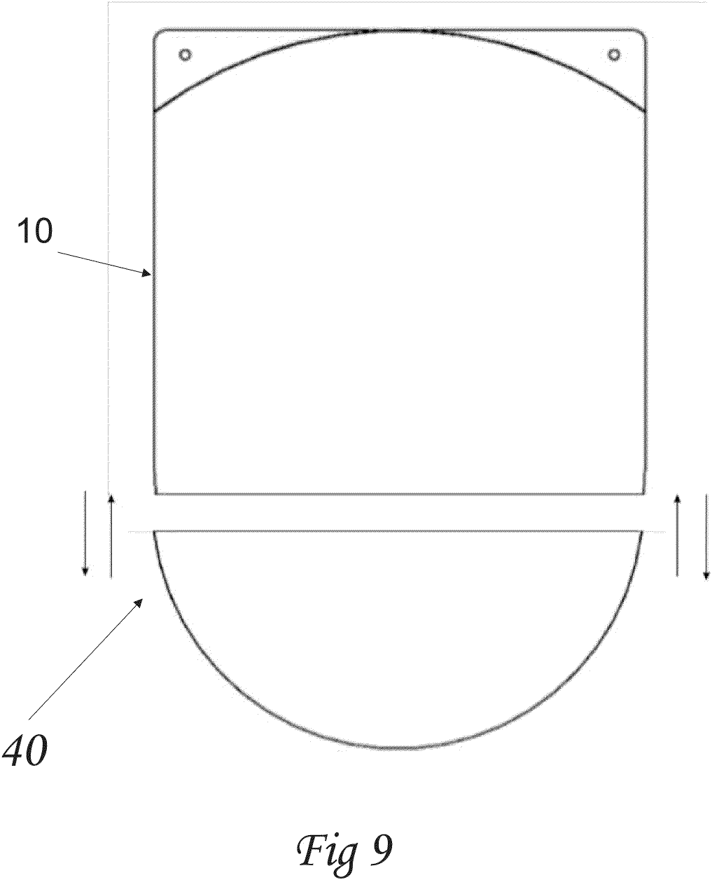

FIG. 9 is a front orthogonal view of the housing 10, a removable chamber 40 slidably residing at the bottom of the housing 10 to remove any fly residue from the housing 10.

FIG. 10 is a front view of the a typical electric fly swatter 20 and fly swatter head 25.

While the invention herein disclosed has been described by means of specific embodiments and applications thereof, numerous modifications and variations could be made thereto by those skilled in the art without departing from the scope of the invention set forth in the claims.

I claim:

1. An electric fly swatter housing comprising:
a front plate;
a back plate;
a mouth at the top of the housing sized for inserting a head of a fly swatter into the housing; and
the front plate and the back plate joined securely creating an interior sized to house the head of the fly swatter.

2. An electric fly swatter housing of claim 1, further including internal vertical bars sized to prevent snag when inserting or removing the head of the fly swatter from the housing.

3. An electric fly swatter housing of claim 1, further including brushes on at least one side of the mouth in intimate contact with the head of the fly swatter when inserting or removing the head of the fly swatter from the housing.

4. An electric fly swatter housing of claim 3, wherein the brushes are on both sides of the mouth.

5. An electric fly swatter housing of claim 1, further including a removable chamber to dispose of any bug residue inside the fly swatter housing.

6. An electric fly swatter housing comprising:
a front plate;
a back plate;
the front plate and the back plate joined securely creating an opening sized to house a fly swatter;
a mouth at the top of the housing sized for inserting a head of the fly swatter into the housing; and
internal vertical bars sized to prevent snag when inserting or removing the fly swatter from the housing.

7. An electric fly swatter housing of claim 6, further including brushes on both sides of the mouth in intimate contact with the head of the fly swatter when inserting or removing the head of the fly swatter from the housing.

8. An electric fly swatter housing of claim 6, wherein there is a removable chamber to dispose of any bug residue inside the housing.

9. An electric fly swatter housing comprising:
a front plate;
a back plate;
the front plate and the back plate joined securely creating an opening sized to easily house a head of a fly swatter;
a mouth at the top of the housing sized for inserting a head of the fly swatter into the housing; and
brushes on both sides of the mouth in intimate contact with the head of the fly swatter when inserting or removing the head of the fly swatter from the housing.

10. A electric fly swatter housing of claim 9, further including a removable chamber to dispose of any bug residue inside the housing.
